(19) United States
(12) Patent Application Publication
(10) Pub. No.: US 2015/0215564 A1
(43) Pub. Date: Jul. 30, 2015

(54) METHODS AND APPARATUS FOR CREATION OF A REFERENCE TIME INDEX FOR AUDIO/VIDEO PROGRAMMING

(71) Applicant: Echostar UK Holdings Limited, Keighley (GB)

(72) Inventor: David John Michael Robinson, North Yorkshire (GB)

(21) Appl. No.: 14/168,181

(22) Filed: Jan. 30, 2014

(51) Int. Cl. H04N 5/445

(52) U.S. Cl. CPC H04N 5/44508

(57) ABSTRACT

A method for adjusting actual timing data associated with closed captioning data for audio/video programming is provided. The method receives a first set of closed captioning data and a first set of actual timing data associated with the first set of closed captioning data, for the audio/video programming; obtains theoretical timing data for the first set of closed captioning data; calculates a timing offset between the first set of actual timing data and the theoretical timing data; and adjusts a second set of actual timing data, based on the calculated timing offset.

### TECHNICAL FIELD

Embodiments of the subject matter described herein relate generally to correcting timing data associated with closed captioning data for a set of audio/video programming, and more particularly, to using corrected timing data to create a reference time index for a set of audio/video content.

### BACKGROUND

Audio/video programming providers often present additional data, targeted advertising, interactive content, and the like, to a television viewer during viewing. Such additional content may be presented simultaneously with the television broadcast via a television in communication with a broadcast content receiver, or via an external electronic device in communication with the broadcast content receiver.

Audio/video content receivers and external electronic devices, and their internally executed software applications, often depend on informational aspects of audio/video programming to perform the additional functions or present additional information to a viewer. For example, a companion screen electronic device (such as a smartphone or tablet computer) may present designated content to a user based on events currently occurring in the show at a certain point in time (e.g., a designated reference point in time) during playback. As another example, using pause and resume services, a person can pause recorded and/or on-demand content on a first device and resume watching the same content, at the same point in time in the show, on a second device. For each of these external software applications, and more that are not described here, a reference point in time is required, from which to perform an operation and achieve the desired functionality.

Accordingly, it is desirable to provide a reference time index for a set of audio/video programming, denoting various points in time throughout a set of audio/video content. Furthermore, other desirable features and characteristics will become apparent from the subsequent detailed description and the appended claims, taken in conjunction with the accompanying drawings and the foregoing technical field and background.

### BRIEF SUMMARY

A method for adjusting actual timing data associated with closed captioning data for audio/video programming is provided. The method receives a first set of closed captioning data and a first set of actual timing data associated with the first set of closed captioning data, for the audio/video programming; obtains theoretical timing data for the first set of closed captioning data; calculates a timing offset between the first set of actual timing data and the theoretical timing data; and adjusts a second set of actual timing data, based on the calculated timing offset.

A method for adjusting actual timing data associated with a pause-point for audio/video programming is provided. The method receives user input indicating a pause-point for the audio/video programming; identifies a set of closed captioning data associated with the indicated pause-point; identifies a set of actual timing data associated with the set of closed captioning data; obtains theoretical timing data for the set of closed captioning data; calculates a timing offset between the set of actual timing data and the theoretical timing data; adjusts the set of actual timing data, based on the calculated timing offset; and transmits the adjusted set of actual timing data to an external electronic device, wherein the adjusted set of actual timing data comprises a resume-point for the audio/video programming.

A set-top box, communicatively coupled to an audio/video content source and a presentation device, utilized to correct a plurality of timestamps for a set of audio/video content is provided. The set-top box is configured to: receive, store, playback, and transmit for display, the set of audio/video content; obtain, from the set of audio/video content, closed captioning data associated with the set of audio/video content and a plurality of actual timestamps associated with the closed captioning data; retrieve a plurality of theoretical timestamps associated with the closed captioning data from a remote server; calculate an offset between one of the plurality of actual timestamps and a corresponding one of a plurality of theoretical timestamps; and determine a plurality of corrected timestamps based on the calculated offset.

A non-transitory, computer-readable medium comprising instructions which, when executed by a computer, perform a method, is provided. The method identifies a first broadcast timestamp for a first caption of a set of broadcast programming; calculates an offset between the first broadcast timestamp and a stored timestamp for the first caption; identifies a second broadcast timestamp for the set of broadcast programming; and corrects the second broadcast timestamp for the second caption, to produce a corrected second broadcast timestamp, based on the calculated offset.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of a system for creating and using a reference time index that is associated with a set of audio/video programming, in accordance with the disclosed embodiments;

FIG. 2 is a schematic block diagram representation of an audio/video content receiver, in accordance with an embodiment;

FIG. 3 is a schematic representation of another system for creating and using a reference time index that is associated with a set of audio/video programming, in accordance with another embodiment;

FIG. 4 is a flowchart that illustrates an embodiment of a method for correcting and utilizing timing data for audio/video programming;

FIG. 5 is a schematic representation of a set of audio/video content, including associated closed-captioning data, in accordance with the disclosed embodiments;

FIG. 6 is a schematic representation of elements associated with audio/video content creation and a registry to include a subset of those elements, in accordance with the disclosed embodiments;

FIG. 7 is a schematic representation of a data path from a registry and the distribution/retrieval of audio/video content, to an audio/video content receiver for use, in accordance with the disclosed embodiments;

FIG. 8 is a schematic representation of a data path from a registry and an audio/video content receiver to an external electronic device for use, in accordance with the disclosed embodiments;

FIG. 9 is a flowchart that illustrates an embodiment of a method for correcting and utilizing timing data to pause and resume audio/video programming across devices; and

FIG. 10 is a schematic representation of a set of audio/video content, including a pause-point and an associated group of captions, in accordance with the disclosed embodiments.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

The subject matter presented herein relates to methods and apparatus used to correct timing data to create a reference time index for a set of audio/video programming. In certain embodiments, a timing offset is calculated between theoretical timing data for a representative set of closed captioning data in the set of audio/video programming, and actual timing data for the representative set acquired during distribution and/or retrieval of the audio/video programming. This timing offset is then used to calculate corrected timing data values (i.e., a corrected and accurate reference time index) for the remainder of the set of audio/video programming. In the context of the present patent application, a reference time index refers to one or more of these corrected/adjusted timing data values. Additionally, for purposes of the present patent application, the terms “audio/video content” and “audio/video programming” are used interchangeably.

In certain embodiments, the reference time index is stored for future retrieval and use. In some embodiments, the reference time index is transmitted to an electronic device for use, such as to pause and resume audio/video programming playback and/or to present coordinated supplemental content, via a companion screen, during playback.

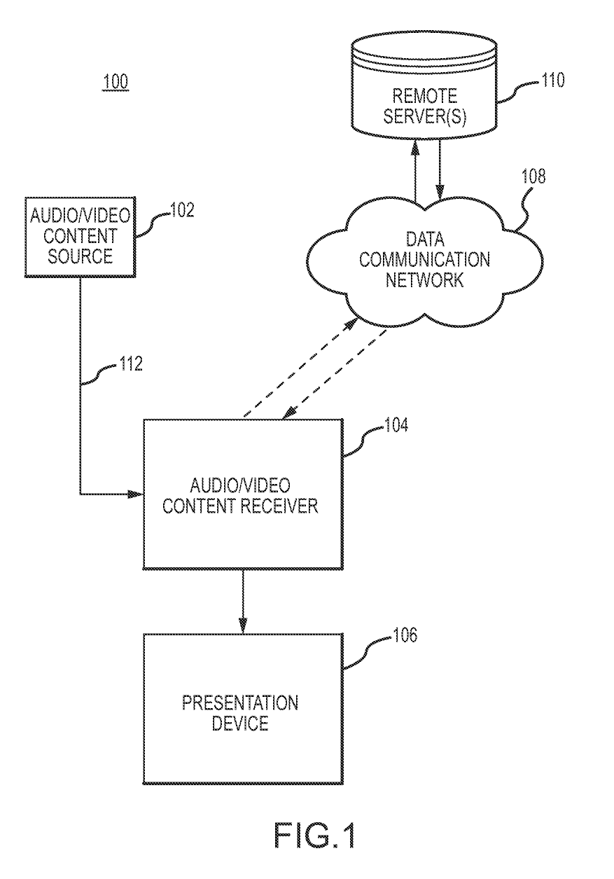

Referring now to the drawings, FIG. 1 is a schematic representation of a system 100 for creating and using a reference time index that is associated with a set of audio/video programming, as described in more detail herein. The system 100 may include, without limitation: an audio/video content source 102; an audio/video content receiver 104; a presentation device 106; a data communication network 108; and at least one remote server 110. It should be appreciated that FIG. 1 depicts a simplified embodiment of the system 100, and that a realistic and practical implementation of the system 100 may include additional elements or components.

The audio/video content source 102 is suitably configured to provide a stream of audio/video content 112 (e.g., audio/video programming) to an audio/video content receiver 104. The audio/video content source 102 may utilize any data communication methodology, including, without limitation: satellite-based data delivery, cable-based data delivery, cellular-based data delivery, web-based delivery, or a combination thereof. In this regard, the system 100 may include or utilize an audio/video content delivery system (not shown). The specific details of such delivery systems and related data communication protocols will not be described here.

During typical operation, the audio/video content receiver 104 receives audio/video content 112 (such as primary program content, including synchronized streams of audio data, video data, closed captioning data, and timing data) signaling information, and/or other data via fiber, internet, wireless, or cellular networks, and/or off-air, satellite, or cable broadcasts. The audio/video content receiver 104 then demodulates, descrambles, decompresses, and/or otherwise processes the received digital data, and then converts the received data to suitably formatted video signals that can be rendered for viewing, and/or stored for future viewing, by the customer on the presentation device 106. The audio/video content receiver 104 is further configured to record received audio/video content 112, and may comprise Digital Video Recorder (DVR) technology. Thus, the audio/video content receiver 104 can record audio/video content 112 and, during playback of the recorded content, be synchronized and utilized cooperatively with a separate and distinct electronic device. This synchronization may be used for purposes of presenting designated “second screen” or “companion screen” content on the electronic device at a designated reference point in time during playback of the recorded audio/video content 112, pausing the recorded content on the audio/video content receiver 104 and resuming playback on the electronic device, and/or performing other operations utilizing the created reference time index for a set of audio/video content 112.

The audio/video content receiver 104 is further configured to retrieve theoretical timing data from at least one remotely located server 110, via the data communication network 108. In practice, the data communication network 108 may be any digital or other communications network capable of transmitting messages or data between devices, systems, or components. In certain embodiments, the data communication network 108 includes a packet switched network that facilitates packet-based data communication, addressing, and data routing. The packet switched network could be, for example, a wide area network, the Internet, or the like. In various embodiments, the data communication network 108 includes any number of public or private data connections, links or network connections supporting any number of communications protocols. The data communication network 108 may include the Internet, for example, or any other network based upon TCP/IP or other conventional protocols. In various embodiments, the data communication network 108 could also incorporate a wireless and/or wired telephone network, such as a cellular communications network for communicating with mobile phones, personal digital assistants, and/or the like. The data communication network 108 may also incorporate any sort of wireless or wired local and/or personal area networks, such as one or more IEEE 802.3, IEEE 802.16, and/or IEEE 802.11 networks, and/or networks that implement a short range (e.g., Bluetooth) protocol. For the sake of brevity, conventional techniques related to video/media communication systems, video/media broadcasting systems, data transmission, signaling, network control, and other functional aspects of the systems (and the individual operating components of the systems) may not be described in detail herein.

The theoretical timing data includes timing data that has been associated with closed captions for a set of audio/video content 112, during creation of the audio/video content 112. When a set of audio/video content 112 (such as a television show) is created, video frames, an audio stream, and associated closed captions are chronologically synchronized, or in other words, the video, audio, and closed captions are aligned in the correct order for presentation. The created presentation is configured to run for a duration of time, and a clock of some sort is used to generate theoretical timing data throughout the created presentation. Here, each caption is associated with a plurality of video frames and coordinating audio data, and each frame is associated with theoretical timing data. The retrieved theoretical timing data includes, at minimum, a first closed caption for a set of audio/video content 112 and timing data associated with the first video frame at which the first closed caption appears.

The retrieved theoretical timing data reflects the previously described initial synchronization, and may be contrasted with actual timing data, which is received with the closed captioning data during the actual distribution and/or retrieval of the set of audio/video content 112. Distribution and/or retrieval of a set of audio/video content 112 may include, without limitation, a television network broadcast, on-demand programming retrieval, internet-based programming distribution or retrieval, or the like. When the set of audio/video content 112, such as a television show, is aired, the television network may have altered the original television show by removing portions, shortening and/or expanding portions, or the like. Such alterations create anomalies between original reference timing data for the television show (e.g., theoretical, or ideal timing data) and the timing data that is associated with each video frame during the distribution and/or retrieval of the audio/video content 112. The retrieved theoretical timing data is typically associated with the set of audio/video content 112 itself, beginning when the set of audio/video content 112 starts and ending when the set of audio/video content 112 ends. However, the actual timing data is associated with a broadcast channel (or other audio/video content 112 provider) rather than the set of audio/video content itself. The actual timing data begins at an arbitrary time selected by an audio/video content 112 provider, runs throughout the day, and has no relationship to the beginning of the set of audio/video content 112. The retrieved theoretical timing data and the actual timing data received during the distribution or retrieval of the audio/video content 112 are used by the audio/video content receiver 104 to create a reference time index.

The audio/video content receiver 104 produces output that is communicated to a presentation device 106. Each audio/video content receiver 104 may include or cooperate with a suitably configured presentation device 106. The presentation device 106 may be implemented as, without limitation: a television set; a monitor; a computer display; a portable electronic device; or any suitable customer appliance with compatible display capabilities. In various embodiments, each audio/video content receiver 104 is a conventional set-top box (STB) commonly used with satellite or cable television distribution systems. In other embodiments, however, the functionality of an audio/video content receiver 104 may be commonly housed within a presentation device 106. In still other embodiments, an audio/video content receiver 104 is a portable device that may be transportable with or without the presentation device 106. An audio/video content receiver 104 may also be suitably configured to support broadcast television reception, video game playing, personal video recording and/or other features as desired.

The audio/video content receiver 104 is further configured to communicate output data to one or more remotely located servers 110, via the data communication network 108. The output data may include a created reference time index for the set of audio/video content 112 and associated closed captioning data. In certain embodiments, the output data is transmitted as a list detailing timing data for an entire set of audio/video programming (e.g., audio/video content 112). However, in some embodiments, the output data is transmitted as individual instances of timing data associated with a closed caption.

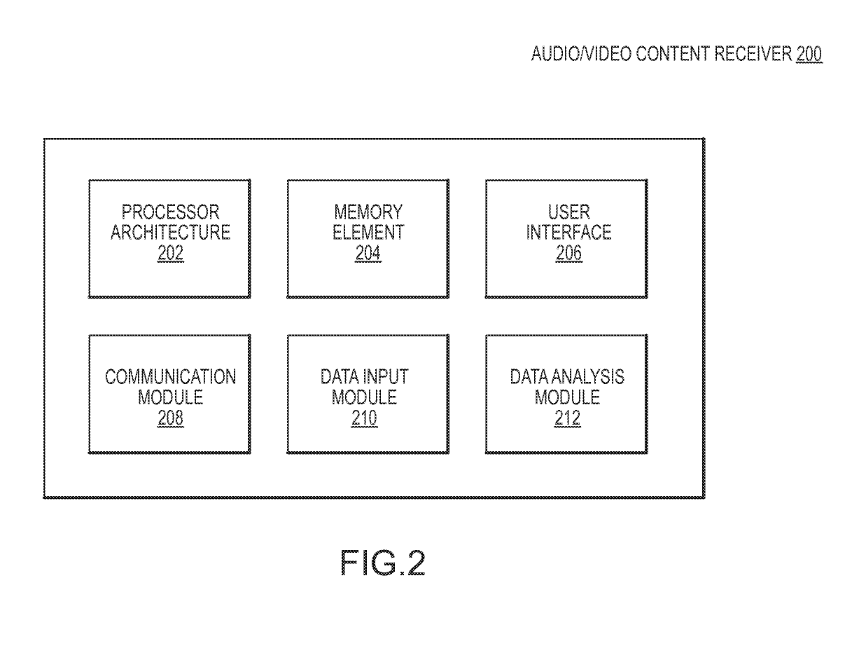

FIG. 2 is a schematic block diagram representation of an audio/video content receiver 200, in accordance with an embodiment. The illustrated embodiment of the audio/video content receiver 200 generally includes, without limitation: a processor architecture 202; a memory element 204; a user interface 206; a communication module 208; a data input module 210; and a data analysis module 212. These components and elements may be coupled together as needed for purposes of interaction and communication using, for example, an appropriate interconnect arrangement or architecture. It should be appreciated that the audio/video content receiver 200 represents a “full featured” embodiment that supports various features described herein. In practice, an implementation of the audio/video content receiver 200 need not support all of the enhanced features described here and, therefore, one or more of the elements depicted in FIG. 2 may be omitted from a practical embodiment. Moreover, a practical implementation of the audio/video content receiver 200 will include additional elements and features that support conventional functions and operations.

The processor architecture 202 may be implemented or performed with one or more general purpose processors, a content addressable memory, a digital signal processor, an application specific integrated circuit, a field programmable gate array, any suitable programmable logic device, discrete gate or transistor logic, discrete hardware components, or any combination designed to perform the functions described here. In particular, the processor architecture 202 may be realized as one or more microprocessors, controllers, microcontrollers, or state machines. Moreover, the processor architecture 202 may be implemented as a combination of computing devices, e.g., a combination of digital signal processors and microprocessors, a plurality of microprocessors, one or more microprocessors in conjunction with a digital signal processor core, or any other such configuration.

The memory element 204 may be realized using any number of devices, components, or modules, as appropriate to the embodiment. Moreover, the audio/video content receiver 200 could include a memory element 204 integrated therein and/or a memory element 204 operatively coupled thereto, as appropriate to the particular embodiment. In practice, the memory element 204 could be realized as RAM memory, flash memory, EPROM memory, EEPROM memory, registers, a hard disk, a removable disk, or any other form of storage medium known in the art. In certain embodiments, the memory element 204 includes a hard disk, which may also be used to support functions of the audio/video content receiver 200. The memory element 204 can be coupled to the processor architecture 202 such that the processor architecture 202 can read information from, and write information to, the memory element 204. In the alternative, the memory element 204 may be integral to the processor architecture 202. As an example, the processor architecture 202 and the memory element 204 may reside in a suitably designed ASIC.

The memory element 204 can be used to store and maintain information for use by the audio/video content receiver 200. For example, the memory element 204 may be used to store retrieved theoretical timing data, received actual timing data, along with associated closed captioning data and time offsets. The memory element 204 may also be utilized to store data concerning a pause-point in a set of audio/video content and/or applicable second screen content references for events in the set of audio/video content. Of course, the memory element 204 may also be used to store additional data as needed to support the operation of the audio/video content receiver 200.

The user interface 206 may include or cooperate with various features to allow a user to interact with the audio/video content receiver 200. Accordingly, the user interface 206 may include various human-to-machine interfaces, e.g., a keypad, keys, a keyboard, buttons, switches, knobs, a touchpad, a joystick, a pointing device, a virtual writing tablet, a touch screen, a microphone, a remote control, or any device, component, or function that enables the user to select options, input information, or otherwise control the operation of the audio/video content receiver 200. For example, the user interface 206 could be manipulated by an operator to pause a set of audio/video content during playback, thereby creating a pause-point to resume at a later time or on another electronic device. In another example, the user interface 206 could be manipulated by an operator to change channels and record, play, and stop playback of audio/video content.

The communication module 208 is suitably configured to receive and perform processing on signals received by the audio/video content receiver 200 and to transmit signals from the audio/video content receiver 200. The communication module 208 is used to communicate data between the audio/video content receiver 200 and one or more remote servers. Moreover, the communication module 208 is further configured to communicate data between the audio/video content receiver 200 and an external electronic device capable of presenting supplemental, coordinated second screen content or capable of resuming a paused set of audio/video programming. As described in more detail below, data received by the communication module 208 includes audio/video content from an audio/video content source (see, for example, FIG. 1). Data provided by the communication module 208 includes a reference time index, or individual reference time index values, for a set of audio/video programming. The communication module 208 may leverage conventional design concepts that need not be described in detail here.

The data input module 210 is suitably configured to receive audio/video content, which may also be referred to as audio/video programming, via the communication module 208. Included in the audio/video programming is closed captioning data and associated actual timing data (e.g., timing data associated with each caption during the actual distribution and/or retrieval of the programming). The closed captioning data identifies the set of audio/video content and presents subtitles, or captions, to viewers of the set of audio/video content. Closed captioning data is typically used as a transcription of the audio portion of a set of audio/video content, as it occurs (either verbatim or in edited form), and may include descriptions of non-speech elements.

In some embodiments, the audio/video programming includes a sequence of video frames with associated actual timing data, formatted in accordance with the Motion Picture Experts Group Transport Stream (MPEG-TS) standard. Timing information for each video frame, including actual timing data and theoretical timing data, may comprise a Presentation Time Stamp (PTS) value. A PTS is a reference timing value that is generally included in packet media streams (digital audio, video or data), according to the MPEG standard. PTS values are used to control the presentation time alignment of such media, through synchronization of separate components within a video content stream (e.g., video, audio, subtitles, etc.). In other embodiments, timing information for each video frame may comprise a Program Clock Reference (PCR) value. As used in association with compressed digital video, a PCR value consists of a time stamp that indicates an associated System Time Clock (STC) value at the time a packet leaves an encoder. Alternatively, an accurate Time of Day clock may be used.

In some embodiments, one or more of the time stamps may use a different format, clock frequency, or unit of time from the others. For example, one clock may be expressed in seconds and fractions of a second; another in hours, minutes, seconds and video frames; another in counts of a high frequency clock (e.g. a 27 MHz clock counting 27 million parts per second); another in counts of blocks of audio samples (where each block has a known fixed duration); another simply as a “wall clock” counting local or universal coordinated time. It will be appreciated that, when the units of time associated with each clock type are known, those skilled in the art will be able to calculate a conversion between them, and incorporate this into the calculations described herein. In some embodiments, (e.g. those based on MPEG-DASH) actual “time stamps” can be sparse or largely absent; between time stamps (or in the absence of time stamps) the timing of audio and video data must be assumed by counting video frames and audio samples (each having a known fixed duration) from the last time stamp (or from some other fixed known point). In applying the invention to such systems (i.e. those without explicit PTSs for every single event, frame, block or sample), what is referred to herein as the PTS should be interpreted as the presentation time that is used by a standard player of a given format, as calculated in accordance with the standard laid down for that format.

The data input module 210 is further configured to retrieve data from a remote server, via the communication module 208. Data retrieved from the remote server may include theoretical timing data (e.g., timing data associated with one or more closed captions at show creation). Additionally, the data input module 210 is configured to receive user input, via the user interface 206, indicating a pause-point in a set of audio/video programming during playback. The pause-point is a point in time, of the duration of the programming, at which the programming has been halted. In certain embodiments, functionality related to the retrieval of data is performed by an external electronic device in communication with the audio/video content receiver 200, instead of being performed by the audio/video content receiver 200 itself.

The data analysis module 212 is suitably configured to compare the retrieved theoretical timing data, associated with one or more closed captions, to the received actual timing data associated with the same one or more closed captions, to calculate an offset timing value. In practice, the data analysis module 212 may be implemented with (or cooperate with) the processor architecture 202 to perform at least some of the functions and operations described in more detail herein. In this regard, the data analysis module 212 may be realized as suitably written processing logic, application program code, or the like.

In certain embodiments, the data analysis module 212 compares a theoretical timestamp (e.g., a PTS) for a first closed caption to an actual timestamp for the same first closed caption. In other words, the data analysis module 212 compares what the value of the timestamp for the first closed caption should be, to the value of the actual distributed and/or retrieved timestamp for the first closed caption in a program. In some embodiments, the data analysis module 212 compares a group (i.e., more than one) of timestamps for a more accurate calculation of the offset timing value. The data analysis module 212 is further configured to use the calculated timing offset to generate a reference time index for an entire set of audio/video programming.

In a first implementation, once the reference time index has been generated, the audio/video content receiver 200 transmits the reference time index to a remote server for storage in a database, via the communication module 208, and/or saves the reference time index in the memory element 204 for future use. However, in a second implementation, the audio/video content receiver 200 transmits the reference time index to an electronic device capable of presenting coordinated “companion screen” or “second screen” content to a user at a designated reference point in time during playback of the audio/video programming, or capable of coordinated pause/resume functionality. In certain embodiments of the second implementation, the audio/video content receiver 200 transmits individual adjusted timing values from the reference time index, to a second screen electronic device, wherein the second screen electronic device is configured to present designated content to a user based on the adjusted timing values. In some embodiments of the second implementation, the audio/video content receiver 200 transmits individual adjusted timing values from the reference time index, to a second screen electronic device, wherein the second screen electronic device is configured to receive data indicating a user-selected point in time for a set of audio/video content, and to playback the set of audio/video content beginning at the user-selected point in time.

In some embodiments of the second implementation, this transmission of individual adjusted timing values from the reference time index occurs at timed intervals, while in other embodiments, the transmission is event-driven, such as in response to a received request from the second screen electronic device. In certain embodiments of the second implementation, the data analysis module 212 is part of an external electronic device (instead of being part of the audio/video content receiver 200) that is configured to communicate with the audio/video content receiver 200 and to present designated and coordinated companion screen content.

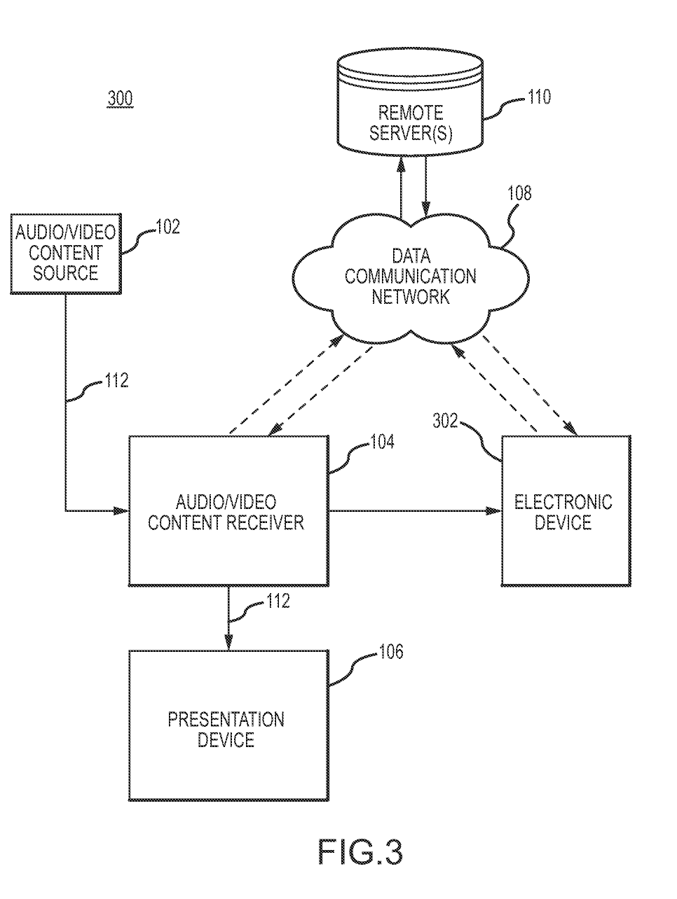

For example, FIG. 3 illustrates another embodiment of a system 300 for creating a reference time index associated with a set of audio/video programming, and for transmitting the reference time index to an electronic device 302 for further use. As shown, the system 300 includes the various parts associated with the system shown in FIG. 1, including, without limitation, an audio/video content source 102; an audio/video content receiver 104; a presentation device 106; a data communication network 108; and one or more remote servers 110. However, the system 300 also includes an electronic device 302, in communication with the audio/video content receiver 104 and the at least one remote server 110 via the data communication network 108. The electronic device is typically implemented as a personal computing device, such as, without limitation: a smartphone, a tablet computer, a laptop computer, a smart-watch, or the like.

Here, just as in FIG. 1, the audio/video content receiver 104 receives a set of audio/video content 112 from the audio/video content source 102, and further transmits audio/video content 112 to a presentation device 106, such as a television set, for viewing. The audio/video content receiver is configured to recognize closed captioning data and actual timing data from the audio/video content 112 itself. In certain embodiments, the audio/video content receiver 104 is further configured to communicate with a remote server 110 via a data communication network 108 (as described above with relation to FIG. 1) to retrieve theoretical timing data for the audio/video content 112, and to compare the theoretical timing data to the actual timing data, based on a particular closed caption, to calculate a timing offset and to calculate a reference time index for closed captions associated with the audio/video content 112 based on the calculated timing offset. In other embodiments, the audio/video content receiver 104 receives the audio/video content 112 and extracts the closed captioning data and the actual timing data, and transmits those values to the electronic device 302. In this example, the electronic device 302 is configured to communicate with a remote server 110 via the data communication network 108 to retrieve theoretical timing data for the set of audio/video content 112, and to compare the theoretical timing values to the actual timing values (for a given closed caption) to generate a timing offset and a reference time index for the rest of the program based on the timing offset.

In embodiments where the reference time index is generated by the audio/video content receiver 104, the reference time index is transmitted by the audio/video content receiver 104 to the electronic device 302 for further use. The audio/video content receiver 104 may transmit corrected timestamps from the reference time index, individually, to the electronic device 302, or the audio/video content receiver 104 may transmit more than one corrected timestamp to the electronic device 302 at a time. Alternatively, the audio/video content receiver 104 may create the reference time index for an entire set of audio/video content and transmit the reference time index to a remote server 110 for future retrieval and use. In this case, the electronic device 302 may retrieve the reference time index, reflecting the actual timing data associated with the closed captions in the set of audio/video content 112, from a remote server 110. Here, the electronic device 302 retrieves both the reference time index and the theoretical timing data from one or more remote servers 110 via the data communication network 108.

As applied to the system 300 shown in FIG. 3: whether the reference time index is generated by the electronic device 302, received directly by the electronic device 302, or retrieved from a remote server 110 by the electronic device, the reference time index arrives and is ultimately used by the electronic device 302. In certain embodiments, the electronic device 302 is configured to present coordinated “companion screen” or “second screen” content to a user, during playback of audio/video content 112 on the audio/video content receiver 104. Designated companion screen content provides additional information to a user regarding specific audio/video content, to be presented to the user while viewing the specific audio/video content. In specific embodiments, second screen content associated with a particular episode of a television program is intended to be viewed by a user simultaneously with the particular episode of the television program. Designated companion screen content may include additional information, interactive content, and content related to a specific set of audio/video programming. More specific examples may include, without limitation: webpages, pop-up text, targeted advertising, interactive content, or the like. Additionally, second screen software applications (“apps”) were developed as a way to allow people to become more engaged with a particular television program during viewing.

In some embodiments, the electronic device 302 is configured to use reference time index values to resume playback of content that has been “paused” by the audio/video content receiver 104. Here, a user may pause audio/video content 112 during playback on the audio/video content receiver 104, creating a pause-point in the set of audio/video programming 112. As is the case with any point in time in the programming, the pause-point may be associated with one or more particular captions (e.g., closed captioning data). Because the actual timing data associated with each caption may be different than theoretical timing data associated with each caption, the audio/video content receiver 104 is configured to obtain the accurate, theoretical timing data. In certain embodiments, the audio/video content receiver 104 obtains the theoretical timing data by performing a lookup (at a remote server 110 via the data communication network 108) to determine the theoretical timing data corresponding to the caption(s) associated with the pause-point. In some embodiments, the audio/video content receiver 104 utilizes a previously determined timing offset to calculate the theoretical timing value(s) associated with caption(s) at the pause-point. In an additional embodiment, the actual and theoretical timing data may be used to calculate a new timing offset, and the newly-calculated timing offset may be used to adjust or “correct” timing data associated with a particular video frame at the pause-point. The theoretical timing data, or the adjusted timing data associated with a video frame, is then transmitted to the electronic device 302 for use as a resume-point, or in other words, a point in time in the duration of the programming at which the program resumes playback.

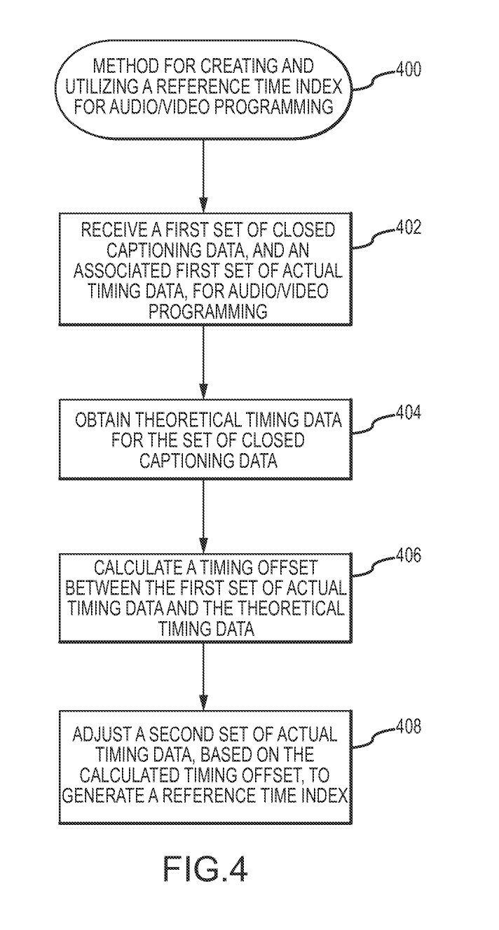

FIG. 4 is a flowchart that illustrates an embodiment of a process 400 for correcting and utilizing a reference time index for audio/video programming. The various tasks performed in connection with process 400 may be performed by software, hardware, firmware, or any combination thereof. For illustrative purposes, the following description of process 400 may refer to elements mentioned above in connection with FIGS. 1-3. In practice, portions of process 400 may be performed by different elements of the described system, e.g., an audio/video content receiver, or an electronic device operating cooperatively with an audio/video content receiver. It should be appreciated that process 400 may include any number of additional or alternative tasks, the tasks shown in FIG. 4 need not be performed in the illustrated order, and process 400 may be incorporated into a more comprehensive procedure or process having additional functionality not described in detail herein. Moreover, one or more of the tasks shown in FIG. 4 could be omitted from an embodiment of the process 400 as long as the intended overall functionality remains intact.

For clarity and ease of illustration, it is assumed that the process 400 begins by receiving a first set of closed captioning data and actual timing data for audio/video programming (step 402). The first set of closed captioning data includes one or more closed captions appearing at a particular point in the duration of a set of audio/video programming Generally, the actual timing data includes a timestamp which references the point in time at which the closed captioning data initially appears within the set of audio/video programming, during the actual distribution and/or retrieval of the audio/video programming.

In certain embodiments, the first set of closed captioning data includes the first caption of a television show, or other form of audio/video programming. In some embodiments, the first set of closed captioning data includes a set of captions (e.g., the first three captions) in the set of audio/video programming. When the first caption is used, a reference time index may be generated for the remaining duration of the set of audio/video programming. However, in some embodiments, the first set of closed captioning data includes one or more captions at another selected time-point in the duration of the set of audio/video programming, and is used to generate a reference time index for a shortened remaining subset of the set of audio/video programming. A caption that is not the first caption, or a group of captions that do not include the first caption, may be used for purposes of verification and/or adjustment to one or more corrected timing values of a previously generated reference time index.

Next, the process 400 obtains theoretical timing data for the set of closed captioning data (step 404). Theoretical timing data includes a timestamp associated with each closed caption at the time the set of audio/video content is created, which occurs before an audio/video content provider (e.g., a broadcaster, television network, on-demand programming provider, internet-based programming provider, or the like) has the opportunity to make changes or adjustments to the set of audio/video programming. The theoretical timing data includes timestamps for all captions in the set of audio/video content. In certain embodiments, the theoretical timing data is retrieved from a remote server. In other embodiments, the theoretical timing data may be packaged and received as part of the set of audio/video content, and extracted once received.

After obtaining the theoretical timing data for the set of closed captioning data (step 404), the process calculates a timing offset between the actual timing data and the theoretical timing data (step 406). Generally, the process 400 compares the same form of timing data for each caption. Here, each caption in the set of closed captioning data appears within a set of multiple video frames, and each video frame includes timing data that is particular to each respective video frame. In certain embodiments, the actual timing data and the theoretical timing data may be implemented as Presentation Time Stamps (PTSs), and the first video frame at which a particular caption appears is associated with a PTS of interest. In this example, a theoretical PTS includes a PTS for the first video frame at which a particular caption appears, as defined by an audio/video content provider when the set of audio/video content is created. Further, an actual PTS also includes a PTS for the first video frame at which a particular caption appears, but the actual PTS reflects the timing of the appearance of the caption (and the associated first video frame) when the set of audio/video content is distributed and/or retrieved for viewing. The comparison between a “theoretical” PTS and an “actual” PTS is simply a comparison between the intended PTS values associated at creation of the audio/video programming, versus the resulting PTS values once the audio/video content has been distributed or retrieved for viewing. In this example, the process 400 compares a theoretical PTS associated with a first caption to a PTS received with the first caption during the actual distribution and/or retrieval of the audio/video content, and determines a timing offset from the two PTS values.

The process 400 then adjusts (i.e., corrects) a second set of actual timing data for the audio/video programming, based on the calculated timing offset (step 408). Using the timing offset, the process 400 “corrects” the actual timing data for the entire set, or a subset, of audio/video programming. Using this corrected actual timing data, in combination with the retrieved theoretical data for the first set of closed captioning data, the process 400 produces an accurate reference time index for the set of audio/video programming. The adjusted actual timing data may be associated with one or more closed captions, one or more video frames, and/or one or more subsets of an audio stream. In certain embodiments, the process 400 uses the calculated timing offset to adjust timing data associated with all of the video frames in a set of audio/video programming, to produce a reference time index. In some embodiments, the process 400 uses the calculated timing offset to adjust timing data associated with an entire audio stream, to produce a reference time index. In some embodiments, the process 400 uses the calculated timing offset to adjust timing data associated with all of the closed captions associated with a set of audio/video programming, to produce a reference time index.

The reference time index may include one or more adjusted actual timing data values. Additionally, the process 400 may associate designated companion screen content with adjusted actual timing data values in the reference time index. More specifically, the process may adjust or correct the timing values associated with designated companion screen content, so that the companion screen content is presented to a user at the appropriate time during playback of a set of audio/video programming. In certain embodiments, the reference time index may be uploaded and stored in a database at a remote server, or stored in internal memory, for future use. In some embodiments, the reference time index is transmitted to an external electronic device, at which designated companion screen content is presented, based on the adjusted actual timing values.

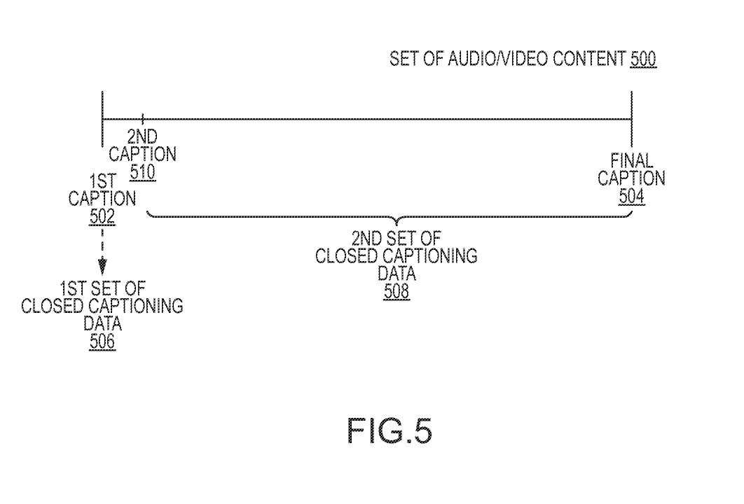

FIG. 5 is a schematic representation of a set of audio/video content 500 and associated closed captioning data, in accordance with one exemplary embodiment of the process of FIG. 4. As shown, the set of audio/video content 500 begins with a first caption 502 and ends with a final caption 504. In this example, the first set of closed captioning data 506 only includes the first caption 502, and the second set of closed captioning data 508 includes all other captions in the set of audio/video content 500, beginning with the second caption 510 and ending with the final caption 504.

As described with respect to FIG. 4, the process receives a first caption 502 and actual timing data (e.g., a timestamp) for the first caption 502 during the actual distribution and/or retrieval of the set of audio/video content 500. Next, the process retrieves a theoretical timestamp for the first caption 502 and calculates a timing offset between the actual and theoretical timestamps. Once the timing offset has been calculated, the process applies the timing offset to each of the actual timestamps associated with each of the captions in the second set of closed captioning data 508 to generate an adjusted timestamp for each caption in the set of audio/video content 500. This new group of adjusted timestamps is also called a reference time index for the set of audio/video content 500.

Although FIG. 5 illustrates one exemplary embodiment of creating a reference time index based on a second set of closed captioning data 508, it should be appreciated that, in other embodiments, the reference time index may also be based on corrected timing values associated with individual video frames and/or audio data in the set of audio/video content 500.

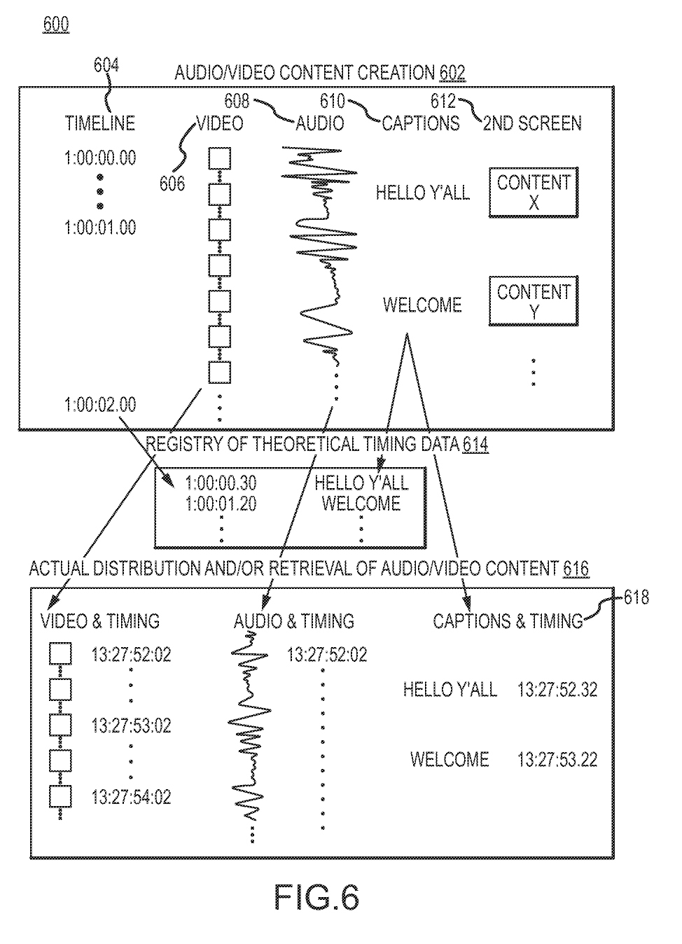

FIG. 6 illustrates a system 600 for audio/video content creation 602, and utilizing the data provided in audio/video content creation 602 to create a registry 614 of theoretical timing values, according to the disclosed embodiments. When a set of the audio/video content is created, a plurality of video frames 606 is synchronized with an audio stream 608, appropriate closed captioning data 610, and in certain embodiments, designated “second screen” or “companion screen” content 612 for presentation on a companion electronic device during playback of the set of audio/video content. Each of these components of the set of audio/video content are synchronized according to a timeline 604, which includes timing information for the entire set of audio/video content.

Each closed caption (of the closed captioning data 610) is associated with an individual timing value from the timeline 604, and a registry 614 of individual timing values associated with closed captions is stored in a database at a remote server for retrieval by an audio/video content receiver and/or an electronic device that is distinct from the audio/video content receiver. This created registry 614 represents the theoretical timing values of each of the closed captions for a set of audio/video programming, or in other words, the timing values associated with the closed captions during creation of the audio/video content, using a clock that starts at the beginning of the set of audio/video content and stops at the end of the set of audio/video content. For recorded or re-broadcast content where the closed captions are available before broadcast, the registry 614 is available immediately. For live content (e.g., audio/video programming being broadcast at approximately the same time as the event occurs, and/or where closed captions are not available before broadcast), the registry 614 is created in real-time, starting at the beginning of the set of audio/video programming and continuing to add entries as the set of audio/video programming progresses and additional data becomes available. In this live scenario, a device accessing the registry 614 may have to repeatedly request theoretical timing data from the registry 614 as the program (e.g., the set of audio/video content) progresses.

During distribution and/or retrieval of audio/video programming, the video frames 606, the audio stream 608, and the closed captioning data 610, are synchronized and presented via a television network or other audio/video content carrier Timing data 618, such as a Presentation Time Stamp (PTS), is used in this synchronization, and is associated with each video frame 606, portions of the audio stream 608, and each caption of the closed captioning data 610. This “actual” timing data 618 may be different than the theoretical timing data (which is also associated with the closed captions for the audio/video content).

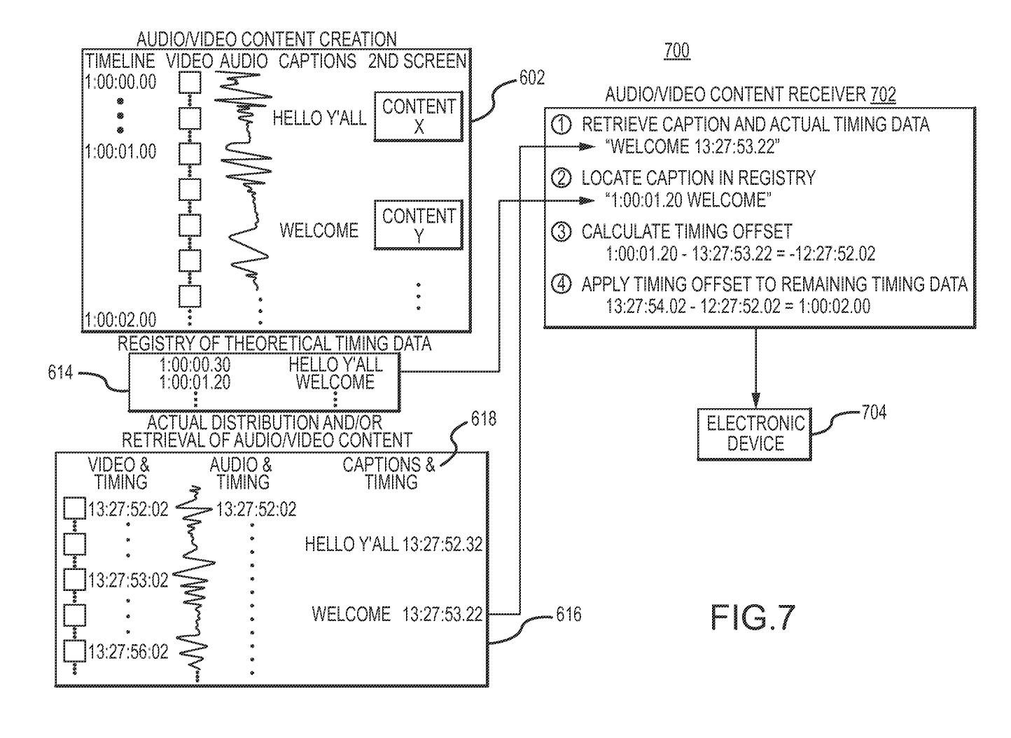

FIG. 7 illustrates a system 700 for creating and using a reference time index for a set of audio/video content, in accordance with an embodiment. The system 700 illustrates audio/video content creation 602, creation of a registry 614 of theoretical timing values, and the creation and transmission of data associated with the actual distribution and/or retrieval of the set of audio/video programming 616 (as shown in FIG. 6) to create the reference time index at an audio/video content receiver 702. The audio/video content receiver 702 then transmits the reference time index to an external electronic device 704 for use.

As shown, the audio/video content receiver 702 retrieves theoretical timing data from the registry 614, which is stored at a remote server. The audio/video content receiver 702 also receives actual timing data and associated closed captions, along with the set of audio/video content, at the time of the actual distribution and/or retrieval of the set of audio/video programming 616 (such as a television network broadcast, on-demand programming retrieval, internet-based programming distribution or retrieval, or the like). The audio/video content receiver 702 calculates the corrected timing values (e.g., a reference time index) and transmits the corrected timing values to the external electronic device 704 via a wireless communication network. Here, the corrected timing values may include adjusted timing values for individual closed captions, individual video frames, and/or subsets of the audio stream.

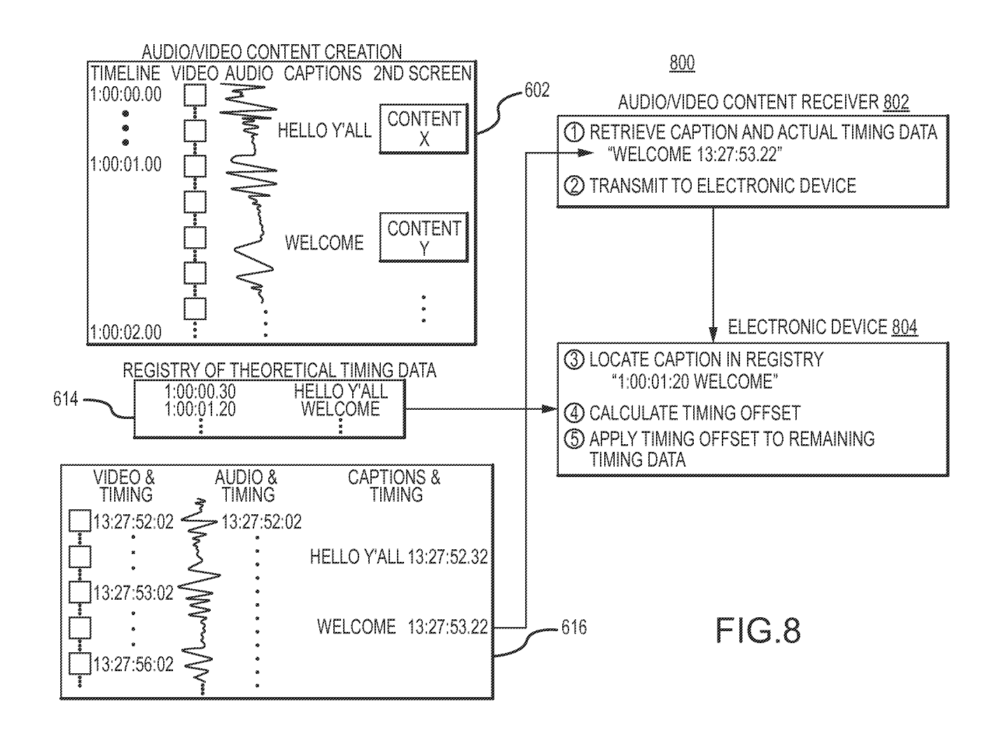

FIG. 8 illustrates another embodiment of a system 800 for creating and using a reference time index for a set of audio/video content. The system 800 illustrates audio/video content creation 602, creation of a registry 614 of theoretical timing values, and the creation and transmission of data in the actual distribution and/or retrieval of the set of audio/video content 616 (as shown in FIGS. 6 and 7) to create the reference time index at an external electronic device 804 in communication with an audio/video content receiver 802.

Here, the audio/video content receiver 802 receives actual timing data and associated closed captions, along with the set of audio/video content, at the time of the actual television network audio/video 616. The audio/video content receiver 802 then transmits the actual timing data and associated closed captions to the external electronic device 804. The external electronic device 804 retrieves theoretical timing data from the registry 614, which is stored at a remote server. The external electronic device 804 then calculates the corrected timing values (e.g., a reference time index) using the received actual timing data, associated captions, and the retrieved theoretical timing data. The corrected timing values may include adjusted timing values for individual closed captions, individual video frames, and/or subsets of the audio stream.

Although FIGS. 6-8 present an exemplary embodiment for creating a reference time index using actual and theoretical timing values associated with text-based closed captions, it should be appreciated that implementations may utilize subtitles or other forms of closed captioning data based on an image of a caption, rather than a text-based caption. Those skilled in the art will adapt the theoretical timing value registry and steps in the process to determine actual, theoretical, and offset timing data for a given subtitle, using fingerprinting or another image compression or mapping algorithm known in the art.

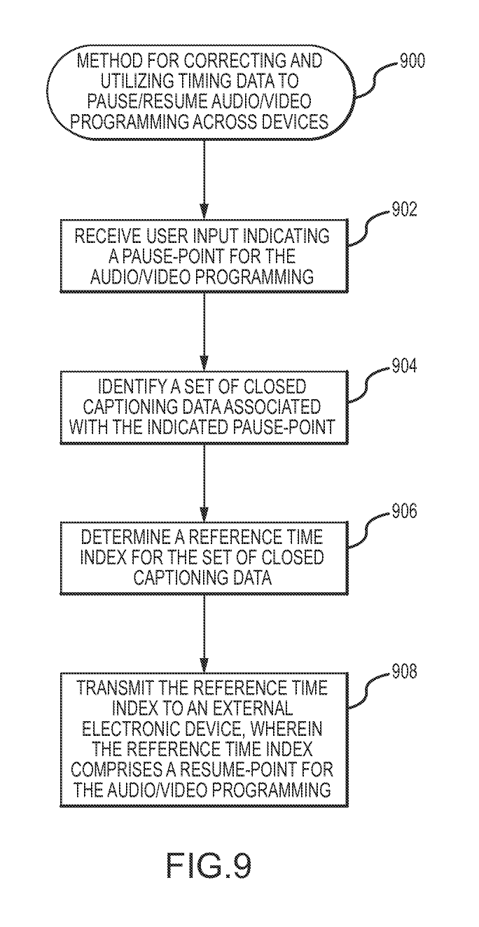

FIG. 9 is a flowchart that illustrates an embodiment of a process 900 for correcting and utilizing timing data to pause and resume audio/video programming across devices. The process 900 is a more specific implementation of the method illustrated in FIG. 4, and the process 900 is performed after the steps in the method illustrated in FIG. 4. First, the process 900 receives user input indicating a pause-point for a set of audio/video programming (step 902). Generally, the user input is received via a user interface of an audio/video content receiver (such as a set-top box), to include an interface physically located on the audio/video content receiver and/or a remote control device. The pause-point halts playback of recorded audio/video content via an audio/video content receiver.

Next, the process 900 identifies a set of closed-captioning data associated with the indicated pause-point (step 904). The pause-point exists at a specific point in time, and this point exists in the duration of the set of audio/video programming. The set of closed-captioning data may include one caption or a group of captions. Each caption is associated with timing data, such as a Presentation Time Stamp (PTS). However, the PTS associated with each caption at the audio/video content receiver is received during the actual distribution and/or retrieval of the audio/video programming, and is reflective of any changes that have been made to the set of audio/video programming by the audio/video content provider. In this implementation, the “actual” PTS values are not transmitted to other devices and/or applications for further use, because other devices and/or applications may utilize a form of the set of audio/video content that has not been changed by that particular audio/video content provider. Therefore, in order to transfer timing information associated with the pause-point for further use, the actual PTS value(s) must be translated, or in other words, adjusted, into timing values that are usable across devices.

After identifying the set of closed-captioning data associated with the indicated pause-point (step 904), the process 900 determines a reference time index for the set of closed captioning data (step 906). Here, the process 900 either performs a lookup to retrieve one or more theoretical time index values from a remote server, or utilizes the known time offset value and the known actual timing data values to calculate the theoretical timing data for each relevant caption. The theoretical time index includes closed captioning data for the entire set of broadcast programming, along with associated theoretical timing data (e.g., theoretical PTS values) for each caption. The process 900 retrieves (or calculates) the theoretical timing data for the caption(s) associated with the pause-point. In this case, the theoretical timing data represents an absolute time index, or a reference time index, that is usable across multiple devices. Here, the reference time index is simply retrieved via a lookup or calculated using known values, and is then transmitted to an external electronic device, wherein the reference time index comprises a resume-point for the set of audio/video programming (step 908). The external electronic device is able to resume playback at the appropriate point, based on the transmitted reference time index.

It should be appreciated that, although the process may merely transmit the theoretical timing data associated with a particular closed caption near the pause-point, the process 900 may also use the actual and theoretical timing data associated with the closed caption to calculate an offset, and then use the calculated offset to adjust or correct timing values associated with a particular video frame at the pause-point. This particular embodiment is more thoroughly described with respect to FIG. 4 and the process of generating a reference time index for an entire set of audio/video programming. Applying this process to a pause-point provides a single adjusted timing value (e.g., a resume-point) that is transferable to an external electronic device for use in audio/video content playback.

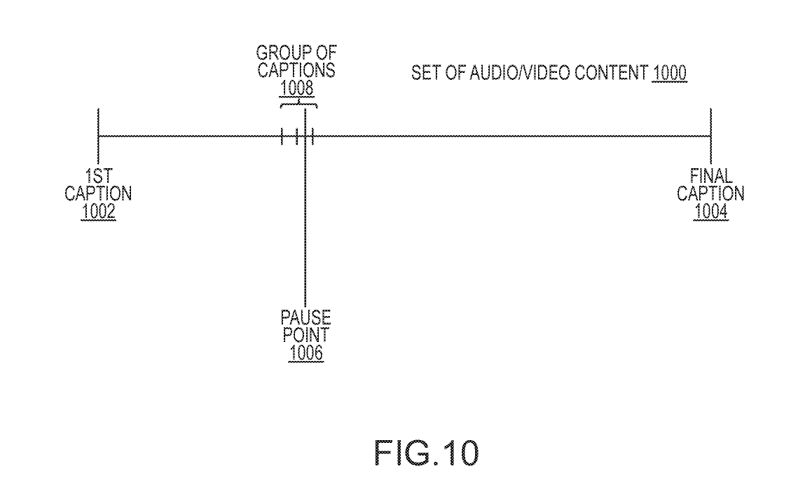

FIG. 10 is a schematic representation of a set of audio/video content 1000 and associated closed captioning data, in accordance with one embodiment of the process of FIG. 9. As shown, the set of audio/video content 1000 begins with a first caption 1002 and ends with a final caption 1004. In this example, the pause point 1006 is located amongst a group of captions 1008 occurring near the time of the pause-point 1006 in the set of audio/video content 1000.

As described with respect to FIG. 9, the process receives user input indicating the pause-point 1006 for the set of audio/video programming 1000, and identifies a set of closed captioning data associated with the indicated pause-point 1006. In this example, the identified set of closed-captioning data is the group of captions 1008. The process then performs a lookup to determine “theoretical” reference time index values for the identified group of captions 1008. The process then transmits the determined reference time index values to an external electronic device, which will use the reference time index values as a reference point at which to resume playback of the set of audio/video content 1000.

Although FIG. 10 illustrates one exemplary embodiment of generating a pause-point compatible for use by an external electronic device, based on an identified group of captions 1008, it should be appreciated that, in other embodiments, the reference time index may also be based on corrected timing values associated with an individual video frame and/or audio data at the user indicated pause-point in the set of audio/video content 1000. Such corrected timing values may be obtained using the process described with regard to FIG. 4.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for adjusting actual timing data associated with closed captioning data for audio/video programming, the method comprising:
receiving a first set of closed captioning data and a first set of actual timing data associated with the first set of closed captioning data, for the audio/video programming;
obtaining theoretical timing data for the first set of closed captioning data;
calculating a timing offset between the first set of actual timing data and the theoretical timing data; and
adjusting a second set of actual timing data, based on the calculated timing offset.

2. The method of claim 1, further comprising:
presenting designated content on a companion screen electronic device, based on the adjusted second set of actual timing data.

3. The method of claim 1, further comprising:
creating a reference time index for the audio/video programming, using the received first set of actual timing data and the adjusted second set of actual timing data; and
storing the reference time index for future use.

4. The method of claim 3, further comprising:
associating the adjusted second set of actual timing data of the created reference time index with designated content; and
presenting the designated content on a companion screen electronic device at the associated reference point during playback of the audio/video programming.

5. The method of claim 1, wherein:
the first set of closed captioning data comprises one or more captions;
the first set of actual timing data comprises a respective presentation time stamp (PTS) associated with an actual broadcast time of each of the one or more captions; and
the theoretical timing data comprises a presentation time stamp (PTS) associated with an original broadcast time of each of the one or more captions.

6. The method of claim 1, wherein the obtaining step further comprises communicating with a remote server to retrieve the theoretical timing data from a stored database.

7. The method of claim 6, wherein the obtaining step further comprises uploading a list comprising the theoretical timing data for the first set of closed captioning data and the adjusted second set of actual timing data for the second set of closed captioning data.

8. The method of claim 1, wherein:
the audio/video programming is associated with a plurality of closed captions;
the first set of closed captioning data comprises a first caption of the plurality of closed captions; and
the second set of actual timing data is associated with a second set of closed captioning data, wherein the second set of closed captioning data comprises each of the plurality of closed captions associated with the audio/video programming, except the first caption.

9. The method of claim 1, wherein the second set of actual timing data is associated with a second set of closed captioning data of the audio/video programming.

10. The method of claim 1, wherein the audio/video programming comprises a plurality of video frames; and
wherein the second set of actual timing data is associated with the plurality of video frames.

11. The method of claim 1, wherein the audio/video programming comprises an audio stream; and
wherein the second set of actual timing data is associated with the audio stream.

12. The method of claim 1, further comprising:
receiving user input indicating a pause-point for the audio/video programming;
identifying the first set of closed captioning data, wherein the first set of closed captioning data is associated with the indicated pause-point;
wherein the adjusted second set of actual timing data is associated with a video frame, the video frame being further associated with the indicated pause-point.

13. A method for adjusting actual timing data associated with a pause-point for audio/video programming, the method comprising:
receiving user input indicating a pause-point for the audio/video programming;
identifying a set of closed captioning data associated with the indicated pause-point;
identifying a set of actual timing data associated with the set of closed captioning data;
obtaining theoretical timing data for the set of closed captioning data;
calculating a timing offset between the set of actual timing data and the theoretical timing data;
adjusting the set of actual timing data, based on the calculated timing offset; and
transmitting the adjusted set of actual timing data to an external electronic device, wherein the adjusted set of actual timing data comprises a resume-point for the audio/video programming.

14. The method of claim 13, wherein the adjusted set of actual timing data is associated with a video frame, the video frame being further associated with the indicated pause-point.

15. A set-top box, communicatively coupled to an audio/video content source and a presentation device, utilized to correct a plurality of timestamps for a set of audio/video content, wherein the set-top box is configured to:
receive, store, playback, and transmit for display, the set of audio/video content;
obtain, from the set of audio/video content, closed captioning data associated with the set of audio/video content and a plurality of actual timestamps associated with the closed captioning data;
retrieve a plurality of theoretical timestamps associated with the closed captioning data from a remote server;
calculate an offset between one of the plurality of actual timestamps and a corresponding one of a plurality of theoretical timestamps; and
determine a plurality of corrected timestamps based on the calculated offset.

16. The system of claim 15, wherein the set-top box is further configured to transmit, at timed intervals, individual ones of the plurality of corrected timestamps to a second screen electronic device;
wherein the second screen electronic device is configured to present designated content to a user based on the individual ones of the plurality of corrected timestamps.

17. The system of claim 15, wherein the set-top box is further configured to transmit, in response to received requests from a second screen electronic device, one of the plurality of corrected timestamps to the second screen electronic device;
wherein the second screen electronic device is configured to present designated content to a user based on the one of the plurality of corrected timestamps.

18. The system of claim 15, wherein the set-top box is further configured to transmit the plurality of corrected timestamps to a remote server for storage in a database.

19. The system of claim 15, wherein the set-top box is further configured to:
create a reference time index for the set of audio/video content, the reference time index comprising at least the plurality of corrected timestamps; and
transmit the reference time index to a remote server.

20. The system of claim 15, wherein the set-top box is further configured to:
receive user input pausing the set of audio/video content at a user-selected point in time during playback; and
transmit a subset of the plurality of corrected timestamps to an electronic device, the subset of the plurality of corrected timestamps corresponding to the user-selected point in time;
wherein the electronic device is configured to:
receive data indicating the user-selected point in time for the set of audio/video content; and
playback the set of audio/video content, beginning at the user-selected point in time.

21. A non-transitory, computer-readable medium comprising instructions which, when executed by a computer, perform a method comprising:
identifying a first broadcast timestamp for a first caption of a set of broadcast programming;
calculating an offset between the first broadcast timestamp and a stored timestamp for the first caption;
identifying a second broadcast timestamp for the set of broadcast programming; and
correcting the second broadcast timestamp, to produce a corrected second broadcast timestamp, based on the calculated offset.

22. The non-transitory, computer-readable medium of claim 21, the method further comprising:
presenting designated content on a second screen electronic device, based on the corrected second broadcast timestamp.

23. The non-transitory, computer-readable medium of claim 21, the method further comprising:
identifying a plurality of captions for the set of broadcast programming;
determining a plurality of corrected timestamps associated with the plurality of captions, based on the calculated offset; and
creating a reference time index for the set of broadcast programming, the reference time index comprising the plurality of corrected timestamps.

24. The non-transitory, computer-readable medium of claim 23, the method further comprising:
associating one of the plurality of corrected timestamps of the created reference time index with designated content; and
presenting the designated content on a second screen electronic device at a point in time referenced by the one of the plurality of corrected timestamps, during playback of the set of broadcast programming.

25. The non-transitory, computer-readable medium of claim 21, the method further comprising:
identifying a pause-point for the set of broadcast programming wherein the first caption is associated with the indicated pause-point;
wherein the corrected second broadcast timestamp is associated with a video frame, the video frame being further associated with the identified pause-point; and
transmitting the corrected second timestamp to an electronic device, wherein the corrected second timestamp comprises a resume-point for the set of broadcast programming.
